(19) United States
(12) Patent Application Publication
(10) Pub. No.: US 2017/0140111 A1
(43) Pub. Date: May 18, 2017

(54) DEVICES, SYSTEMS, AND METHODS FOR INCREASING HAND HYGIENE COMPLIANCE

(71) Applicant: HYGIENE IMPROVING TECHNOLOGY, LLC, Valencia, CA (US)

(72) Inventors: Allen Eli Karz, Valencia, CA (US); William Mirahem, Saugus, CA (US)

(21) Appl. No.: 15/349,861

(22) Filed: Nov. 11, 2016

Related U.S. Application Data
(60) Provisional application No. 62/285,936, filed on Nov. 14, 2015.

(51) Int. Cl. G06F 19/00; G06F 21/62

(52) U.S. Cl. CPC G06F 19/327; G06F 19/321; G06F 21/6245; G06F 19/324

(57) ABSTRACT

A hand hygiene compliance system. The hand hygiene compliance system may comprise: at least one wash station, at least one access station, and at least one room monitor. Each wash station may comprise a wash station computer for accessing patient data. The access station may comprise an access station computer configured to transmit the patient data to the wash station computer in order to display patient data to the user. The wash station computer may allow the user to select one or more target patients to receive images of user washing and to be visited after washing, and each target patient may be associated with the room monitors. The wash station computer may comprise a camera for capturing one or more images of the user washing, and these images may be transmitted to the room monitors associated with the target patients.

### CROSS-REFERENCE TO RELATED APPLICATIONS

This U.S. Non-Provisional Patent Application claims the benefit of U.S. Provisional Patent Application No. 62/285,936, filed on Nov. 14, 2015, titled “Hand hygiene/watch video/patient views washing”, by co-inventors Allen Eli Karz and William Mirahem, the contents of which are expressly incorporated herein by this reference as though set forth in their entirety.

### FIELD

The present disclosure relates generally to devices, systems, and methods for increasing hand hygiene compliance, and more specifically, to a hand hygiene compliance system utilizing a computer-based wash station for use in a facility (e.g., medical facility, hospital) that allows an individual (e.g., a patient) to view one or more images or video stream of a user, such as an employee (e.g., healthcare worker), washing his or her hands before visiting and interacting with the individual. Preferably, the computer-based wash station displays one or more videos to encourage the employee to wash his or her hands in order to increase hand-washing compliance.

### BACKGROUND

Health care-associated infections (“HAI”) acquired in hospitals and other medical care facilities are a major cause of morbidity and mortality for visiting patients. This, in turn, generally leads to significant expenses to the hospitals and medical care facilities and has been exacerbated by the fact that patients are living longer, and are thus, sicker and/or more susceptible to infections. Additionally, the efficacy of antibiotics to fight these hospital infections is usually waning due to over or prior use and the evolution of antibiotic resistance bacteria. The Centers for Medicare and Medicaid Services, the federal agency responsible for Medicare, no longer pays for longer hospital stays due to increased chances of a hospital acquired infection, which may lead to large monetary losses for the hospitals.

The primary way to reduce these infections is proper hand hygiene by all visitors, hospital personnel (e.g., healthcare workers (HCW)), and anyone else who has contact with the patient or objects within the patient's room. Examples of such visitors and hospital personnel may include: doctors, nurses, laboratory workers, respiratory therapists, transporters, housekeepers, physical and occupational therapists, hospital visitors, and patients. Many hospitals employ fulltime personnel to encourage infection control, monitor and assess compliance, and create systems to improve hand hygiene compliance. These employees generally use a technique known as “secret shopper” to assess compliance, whereby an unobtrusive observer watches personnel and determines whether they have washed their hands after entering and exiting patient rooms. Present “secret shopper” assessment methods are inadequate because these assessments only capture a small percentage of the total number of washing opportunities, and it is difficult to determine whether a HCW has washed his or her hands when traveling from a room within sight of “secret shopper” observer to a room out of sight. It is also not possible for a “secret shopper” observer to tell if a HCW has gone from one patient to the next without proper hand washing if both patients are within the same room and the second patient is not in the line of sight.

One reason that hand hygiene compliance is low is because hand hygiene compliance guidelines may require HCWs to wash their hands hundreds of times daily. This may subject the hands of the HCW to chapping, chaffing, or other painful conditions. Present compliance rates are generally no higher than fifty (50%) percent. Thus, improvement in hand hygiene compliance is needed. Because hand washing is a vital component of infection control, current guidelines by regulatory and advisory organizations such as the Center for Disease Control encourage and empower patients and their family members to be proactive in reminding HCWs to wash their hands before and after interacting with the patient. However, this is not yet a standard and expected practice by patients and families. Thus, these patients and families have been far hesitant to remind the HCWs to wash, as it might pose questions to the HCW's work ethic and integrity and antagonize the very person responsible for the patient's care. Asking patients to remind staff about performing hand hygiene has also been criticized by some experts, who argue that hand hygiene is a fundamental ethical responsibility of all HCWs. Thus, few patients currently question the HCW as to whether that worker practiced proper hand hygiene. This system eliminates the need to ask the HCW if they washed because the system shows the HCW washing while watching an entertaining video. This changes a potentially adversarial situation to a cooperative one.

Traditional hand hygiene compliance systems may encourage and monitor hand washing, usually by emphasizing surveillance and enforcement. These systems may include sensor badges worn by the HCW that sense proximity to an anti-bacterial gel dispenser and/or hand washing station that must be used before entering a patient's room. An alarm may sound if the HCW then approaches the patient without having used the hand washing station or gel dispenser. Another traditional system may include a badge that detects alcohol in the anti-bacterial gel. In the event the badge does not detect alcohol before the HCW enters a patient's room, an alarm or notification may also sound. Other hand hygiene compliance systems may utilize camera surveillance to monitor and record whether the HCW washes before and/or after entering a patient's room, but these systems may create invasion of privacy issues with the patient.

Importantly, prior to the present disclosure, no system specifically and automatically demonstrated to a patient that the HCW that is about to visit the patient has washed his or her hands.

Accordingly, what is needed is a hand washing device, system, and method, which records and displays to a patient the HCW washing his or her hands immediately before seeing a patient. Preferably, the hand washing device, system, and method may utilize a computer-based wash station to display one or more musical wash videos to encourage the employee or HCW to wash his or her hands in order to increase hand-washing compliance.

### SUMMARY OF EMBODIMENTS

To minimize the limitations in the cited references, and to minimize other limitations that will become apparent upon reading and understanding the present specification, the present specification discloses a new and useful hand hygiene compliance system.

One embodiment may be a hand hygiene compliance system, comprising: at least one wash station computer; and at least one room monitor; wherein the at least one wash station computer may be located at a wash station and may be configured to access a patient data from a server through a network; wherein the at least one wash station computer may display to a user the patient data to allow the user to select at least one target patient to be visited after washing; wherein the at least one target patient may be associated with the at least one room monitor; and wherein the wash station computer may comprise a camera configured to capture one or more images of the user washing, the one or more images being transmitted to the at least one room monitor associated with the at least one target patient, such that the at least one room monitor displays the one or more images of the user washing to the at least one target patient. The at least one wash station computer may display to the user a plurality of videos; and wherein the at least one wash station computer may be configured to allow the user to select at least one of the plurality of videos to be played during washing. The system may further comprise at least one access station computer located at an access station and in communication with the server, the at least one access station computer being configured to transmit the patient data to the at least one wash station; wherein the access station may be configured to recognize the user; and wherein the at least one wash station may be configured to recognize the user. The one or more wash stations may comprise a first identification reader in communication with the at least one wash station computer and may be configured to recognize a badge associated with the user; and wherein the at least one access station may comprise a second identification reader that is configured to recognize the badge associated with the user. The wash station computer may comprise a touch screen display. The patient data displayed to the user may be based on an identity of the user. The patient data comprises a plurality of patient names and a plurality of patient room numbers; and wherein the plurality of patient names and the plurality of patient room numbers may correspond to each other. The system may further comprise a server having a database; and wherein the database may be configured to store the patient data, the one or more images of the user washing, and the identity of the user. The at least one access station computer may be configured to accept a plurality of visitation data related to the at least one target patient after visiting. The server, the at least one access station computer, the at least one wash station computer, and the at least one room monitor may be in communication via a network. The server may be configured to generate a plurality of usage reports and a plurality of compliance reports. At least a summary of the plurality of usage reports and the plurality of compliance reports may be accessible to the user. The at least one selected video may be displayed to the user for approximately 20 seconds to serve as a timer for washing. The at least one selected video may be longer than 20 seconds, and the at least one wash station computer may display a different approximately 20 second portion of the at least one selected video when the user selects the at least one selected video a second time at a second washing.

Another embodiment may be a hand hygiene compliance system, comprising: one or more access station computers; one or more wash station computers; and one or more room monitors; wherein the one or more access station computers may be located at one or more access stations and may be configured to allow a user to access a patient data from a server through a network and may transmit the patient data to the one or more wash station computers; wherein the one or more wash station computers may be located at one or more wash stations and may be also configured to display to a user the patient data to allow the user to select one or more target patients to be visited after washing; wherein the one or more wash station computers may also be configured to allow the user to select one or more videos to be played during the washing; wherein the one or more target patients may be associated with the one or more room monitors; wherein the one or more wash station computers may comprise one or more cameras configured to capture one or more images of the user washing, the one or more images being transmitted to the one or more room monitors associated with the one or more target patients, such that the one or more room monitors may display the one or more images of the user washing to the one or more target patients; wherein the one or more wash stations may comprise a first radio frequency identification reader that is configured to recognize a radio frequency identification badge associated with the user; and wherein the one or more access stations may comprise a second radio frequency identification reader that is configured to recognize the radio frequency identification badge associated with the user. The one or more wash station computers may comprise a touch screen display; wherein the patient data displayed to the user may be based on an identity of the user and may comprise a plurality of patient names and a plurality of patient room numbers; and wherein the plurality of patient names and the plurality of patient room numbers may correspond to each other. The system may further comprise a server, having a database; and wherein the database may be configured to store the patient data, the one or more images of the user washing, and the identity of the user; wherein the one or more access station computers may be configured to accept a plurality of visitation data related to the one or more target patients after visiting; and wherein the server, the at one or more access station computers, the one or more wash station computers, and the one or more room monitors may be in communication via a local area network. The server may be configured to generate a plurality of usage reports and a plurality of compliance reports; and wherein at least a summary of the plurality of usage reports and the plurality of compliance reports may be accessible to the user. The plurality of videos may be displayed to the user for approximately 20 seconds and may serve as a timer for washing. The at least one of the one or more selected videos may be longer than 20 seconds, and the one or more wash station computers may display a different approximately 20 second portion of the one or more videos when the user selects a second video during a second washing.

Another embodiment may be a hand hygiene compliance system, comprising: one or more wash stations; one or more access stations; and one or more room monitors; wherein each of the one or more access stations may comprise at least one computer that is configured to be used by a user to access a patient information; wherein the at least one computer may be configured to transmit the patient information to the one or more wash stations; wherein each of the one or more wash stations may comprise at least one wash station computer; wherein the at least one wash station computer may display to the user the patient information; wherein the at least one wash station computer may be configured to allow the user to select a patient to be visited after washing; wherein the patient to be visited may be associated with at least one of the one or more room monitors; wherein the wash station computer may comprise a camera; wherein the camera may capture one or more images of the user washing that are transmitted to the at least one room monitor that is associated with the patient to be visited after washing; and wherein the at least one room monitor may display the one or more images of the user washing to the patient to be visited after washing. The at least one wash station computer may display to the user a plurality of videos; and wherein the at least one wash station computer may be configured to allow the user to select at least one of the plurality of videos to be played during washing. The one or more wash stations may be configured to recognize the user and wherein the one or more access stations are configured to recognize the user. The one or more wash stations may comprise a radio frequency identification reader that is configured to recognize a radio frequency identification badge worn by and associated with the user; and wherein the one or more access stations may comprise a radio frequency identification reader that is configured to recognize a radio frequency identification badge worn by and associated with the user. The wash station computer may comprise a touch screen display. The patient information displayed to the user may be based on an identity of the user. The patient information may comprise a plurality of patient names and a plurality of patient room numbers; and wherein the plurality of patient names and the plurality of patient room numbers may correspond to each other. The system may further comprise a server, wherein the server may comprise a database; and wherein the database may be configured to store the patient information, the one or more images, and the identity of the user. The at least one access station computer may be configured to accept a plurality of visit information related to the patient to be visited after visiting. The server, the at least one access station computer, the at least one wash station computer, and the one or more room monitors may be connected via a local area network. The server may be configured to generate a plurality of usage reports and a plurality of compliance reports. At least a summary of the plurality of usage reports and the plurality of compliance reports may be displayed. The at least one selected video may be displayed to the user for approximately 20 seconds and act as a timer for washing. The at least one selected video may be longer than 20 seconds and a different approximately 20 second portion of the at least one selected video may be displayed to the user when the user selects the at least one selected video a second time at a second washing.

Another embodiment may be a hand hygiene compliance system, comprising: one or more wash stations; one or more access stations; and one or more room monitors; wherein each of the one or more access stations may comprise at least one computer that is configured to be used by a user to access a patient information; wherein the at least one computer may be configured to transmit the patient information to the one or more wash stations; wherein each of the one or more wash stations may comprise at least one wash station computer; wherein the at least one wash station computer may display to the user the patient information and a plurality of videos; wherein the at least one wash station computer may be configured to allow the user to select a patient to be visited after washing and to allow the user to select at least one of the plurality of videos to be played during washing; wherein the patient to be visited may be associated with at least one of the one or more room monitors; wherein the wash station computer may comprise a camera; wherein the camera may capture one or more images of the user washing that are transmitted to the at least one room monitor that is associated with the patient to be visited after washing; wherein the at least one room monitor may display the one or more images of the user washing to the patient to be visited after washing; wherein the one or more wash stations may comprise a radio frequency identification reader that is configured to recognize a radio frequency identification badge worn by and associated with the user; and wherein the one or more access stations may comprise a radio frequency identification reader that is configured to recognize a radio frequency identification badge worn by and associated with the user. The wash station computer may comprise a touch screen display; and wherein the patient information displayed to the user may be based on an identity of the user; wherein the patient information may comprise a plurality of patient names and a plurality of patient room numbers; and wherein the plurality of patient names and the plurality of patient room numbers may correspond to each other. The system may further comprise a server, wherein the server may comprise a database; and wherein the database may be configured to store the patient information, the one or more images, and the identity of the user; wherein the at least one access station computer may be configured to accept a plurality of visit information related to the patient to be visited after visiting; and wherein the server, the at least one access station computer, the at least one wash station computer, and the one or more room monitors may be connected via a local area network. The server may be configured to generate a plurality of usage reports and a plurality of compliance reports; wherein at least a summary of the plurality of usage reports and the plurality of compliance reports may be displayed. The plurality of videos may be displayed to the user for approximately 20 seconds and may act as a timer for washing. The at least one selected video may be longer than 20 seconds and a different approximately 20 second portion of the at least one selected video may be displayed to the user when the user selects the at least one selected video a second time at a second washing.

Another embodiment may be a hand hygiene compliance system, comprising: one or more wash stations; one or more access stations; and one or more room monitors. Each of the one or more access stations may comprise at least one computer that is configured to be used by a user to access a patient information. The at least one computer may be configured to transmit the patient information to the one or more wash stations. Each of the one or more wash stations may comprise at least one wash station computer, wherein the at least one wash station computer may display to the user the patient information. The at least one wash station computer may be configured to allow the user to select a patient to be visited after washing. The patient to be visited may be associated with at least one of the one or more room monitors. The wash station computer may comprise a camera, wherein the camera may capture one or more images of the user washing that are transmitted to the at least one room monitor that is associated with the patient to be visited after washing. The at least one room monitor may display the one or more images of the user washing to the patient to be visited after washing. The at least one wash station computer may display to the user a plurality of videos, which may be selected by the user so that one of the videos may be played during washing. The one or more wash stations and access stations may be configured to recognize the user when the user approaches the station. The one or more wash stations may comprise a radio frequency identification reader that may be configured to recognize a radio frequency identification badge worn by and associated with the user. The one or more access stations may also comprise a radio frequency identification reader that may be configured to recognize a radio frequency identification badge worn by and associated with the user. Preferably, the wash station computer comprises a touch screen display. The patient information may be displayed to the user may be based on an identity of the user. The patient information may comprise a plurality of patient names and a plurality of patient room numbers. The plurality of patient names and the plurality of patient room numbers preferably correspond to each other.

The system may further comprise a server, having a database; and wherein the database may be configured to store the patient information, the one or more images, and the identity of the user or other information related to the patients and users. The at least one access station computer may be configured to accept a plurality of visit information related to the patient to be visited after visiting. The server, the at least one access station computer, the at least one wash station computer, and the one or more room monitors may be connected via a local area network. The server may be configured to generate a plurality of usage reports and a plurality of compliance reports. A summary of the plurality of usage reports and the plurality of compliance reports may be displayed, such as on a scoreboard. The at least one selected video may be displayed to the user for approximately 20 seconds and act as a timer for washing. The at least one selected video may be longer than 20 seconds and a different approximately 20 second portion of the at least one selected video may be displayed to the user when the user selects the at least one selected video a second time at a second washing.

In various embodiments, these videos may include musical wash videos. Preferably, these musical wash videos are starred in and made by the healthcare workers (HCW) of the health care facility itself. This fosters creativity, camaraderie and unity among healthcare facility staff. This unites HCW's from all sectors i.e. nurses, doctors, respiratory therapists, lab workers, physical and occupational therapists, housekeeping, transportation, obstetrics and fosters friendly competition to see who obtains the most user “hits” and therefore has the best department and individual HCW compliance.

To further foster creativity, the HCW may select “web” on touch screen to bring up a website variety of choices with content that the individual HCW can configure and load personally from his personal computer to a YouTube address. A local physician recently went on a photographic safari to Africa and will enjoy reviewing his wildlife photos each time he washes prior to and after seeing a patient. A visitor to the hospital may be furnished a badge allowing sign on the wash station computer (WSC) and will be able to access local news. There may be a choice of “C” cable to allow 20 second snippets of a HCW's favorite cable series wherein he/she can anticipate watching the next 20 seconds during next washing.

It is an object to provide a hand hygiene compliance system that makes hand washing an entertaining experience. Compliance may also be increased because the healthcare worker (“HCW”) understands that his or her hand washing, or lack thereof, is going to be displayed to the target patient about to be seen by the HCW.

It is an object to provide a hand hygiene compliance system that provides reassurance to patients and their families that the user or HCW has washed his or her hands, which eliminates the need to directly question the HCW about compliance.

It is an object to increase hand hygiene compliance due to the hand washing compliance system disclosed herein that may substantially reduce the human suffering, death, and monetary cost to healthcare facilities as a result of prevented infections.

It is an object to provide a system that simplifies compliance monitoring, gathering metrics, and results in a large, continually available database of images or videos that show hand hygiene compliance.

The present system may comprise a software component that allows the user to show compliance before seeing each and every patient.

It is an object of the system of the present disclosure to increase compliance by making hand hygiene entertaining and rewarding. It is also an objective to show/stream the healthcare worker washing his or her hands right before seeing the patient to reassure the patient and family. It is an objective to decrease: (1) the cost to hospital of compliance monitoring; (2) hospital acquired infections; and (3) the costs resulting from infections.

It is an objective to overcome the limitations of the prior art.

Other features and advantages will become apparent to those skilled in the art from the following detailed description and its accompanying drawings.

### BRIEF DESCRIPTION OF THE DRAWINGS

The drawings show illustrative embodiments, but do not depict all embodiments. Other embodiments may be used in addition to or instead of the illustrative embodiments. Details that may be apparent or unnecessary may be omitted for the purpose of saving space or for more effective illustrations. Some embodiments may be practiced with additional components or steps and/or without some or all components or steps provided in the illustrations. When different drawings contain the same numeral, that numeral refers to the same or similar components or steps.

FIG. 1 is an illustration of one embodiment of a hand hygiene compliance system.

FIG. 2 is an illustration of one embodiment of a wash station and shows the wash station in more detail.

FIG. 3 is an illustration of one embodiment of a room monitor for a patient.

FIG. 4 is an illustration of one embodiment of access station with an access station computer.

FIG. 5 is an illustration of one embodiment of a graphical user interface of a wash station computer.

FIG. 6 is a flow block diagram of one embodiment of the method using the hand hygiene compliance system.

FIG. 7 is another flow diagram of one embodiment for the hand hygiene compliance system and shows how a user utilizes the hand hygiene compliance system.

FIG. 8 is a flow chart of another embodiment of a method of using the hand hygiene compliance system.

FIGS. 9A to 9V are illustrations of another embodiment of a method of using the hand hygiene compliance system and shows a healthcare worker using the hand hygiene compliance system when visiting three patients consecutively.

### DETAILED DESCRIPTION OF THE DRAWINGS

In the following detailed description of various embodiments, numerous specific details are set forth in order to provide a thorough understanding of various aspects of the embodiments. However, these embodiments may be practiced without some or all of these specific details. In other instances, well-known procedures and/or components have not been described in detail so as not to unnecessarily obscure aspects of the embodiments.

While some embodiments are disclosed here, other embodiments will become obvious to those skilled in the art as a result of the following detailed description. These embodiments are capable of modifications of various obvious aspects, all without departing from the spirit and scope of protection. The Figures, and their detailed descriptions, are to be regarded as illustrative in nature and not restrictive. Also, the reference or non-reference to a particular embodiment shall not be interpreted to limit the scope of protection.

In the following description, certain terminology is used to describe certain features of one or more embodiments. For example, as used herein, the terms “computer”, “computing device”, or “computer system” refer to any device or machine that processes data or information with an integrated circuit chip, including without limitation, personal computers, mainframe computers, workstations, testing equipment, servers, desktop computers, portable computers, laptop computers, embedded computers, wireless devices including cellular phones, personal digital assistants, tablets, tablet computers, smartphones, portable game players, and hand-held computers. Computing devices may also include mobile computing devices such as smartphones, tablets, wearables, and the like.

As used herein, the terms “application”, “software”, and “software application” generally refer to any set of machine-readable instructions on a client machine, web interface, and/or computer system, that directs a computer's processor to perform specific steps, processes, or operations disclosed herein. The “application”, “software”, and “software application” may comprise one or more modules that direct the operation of the computing device or computer system. For purposes of this specification, a module may be implemented as a hardware circuit comprising custom VLSI circuits or gate arrays, off-the-shelf semiconductors such as logic chips, transistors, or other discrete components.

As used herein, the terms “network” and “computer network” generally refer to any telecommunications network that allows computers to exchange data. The connections between nodes of the network may be established using either cable media or wireless media.

As used herein, the term “Internet” generally refers to any collection of networks that utilizes standard protocols, whether Ethernet, Token ring, Wi-Fi, asynchronous transfer mode (ATM), Fiber Distributed Data Interface (FDDI), code division multiple access (CDMA), global systems for mobile communications (GSM), long term evolution (LTE), or any combination thereof.

As used herein, the terms “badge”, “identification badge”, and “wireless badge” generally refer to any device or apparatus that may be worn, fastened, secured, attached to, placed on, and/or proximately associated with a user such as an employee or HCW. For example, the badge or wireless badge may be worn by an individual as a wearable (e.g., pin, lapel pin, cufflink, wristband, belt, belt accessory, watch, clip on, ring, bracelet, hat, shirt). Examples of a badge may include radio frequency identification badges for radio frequency identification readers.

As used herein, the terms “identification reader”, “scanner”, “reader”, “identification scanner”, and “identification mechanism” generally refer to any hand-held or stationary input device used to capture and read information from another object or device. For example, in one embodiment, the identification reader may be a scanner or radio frequency identification reader that scans or reads a badge or transmitter with radio frequency capabilities. In another embodiment, the identification reader may utilize infrared technology and may use an infrared receiver, or IR receiver, for receiving information from an infrared remote control by receiving and decoding signals. Still, in another embodiment, the identification reader may be a simple barcode scanner used to read barcodes for identification or a QR scanner used to read QR-type codes.

As used herein, the term “facility” generally refers any building designed, built, installed, etc., to serve a specific function affording a convenience or service, such as a hospital.

As used herein, the term “located at” generally refers to at the same location or proximately near the target location. For instance, in one embodiment, a wash station computer which is “located at” the wash station may be physically coupled to the wash station or may be positioned within a few feet from the wash station.

As used herein, for purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 1-10% from the indicated number or range of numbers.

The present specification discloses a hand hygiene compliance system that may comprise the following subsystems: one or more access stations (which are also referred to as nurse stations) with one or more access station computers (or hospital computers); one or more wash stations; one or more patient room monitors (display devices); and a network (e.g., a local area network (LAN)), wireless or wired, which connect the subsystems. The hand hygiene compliance system may be controlled and/or maintained by a server (e.g., web server), which communicates with the hand-wash subsystems via the network (LAN/Wi-Fi®/Ethernet/etc . . . ). The system may be autonomous system but can be integrated with other computer systems of the facility.

Although the system is preferably integrated into a medical care facility, such as a hospital, where it will have the most benefit, the system may be implemented in any facility where hand washing compliance is important. For example, the hand hygiene compliance system may also be implemented in fast food restaurants, convalescence homes, skilled nursing facilities, board and care facilities and wherever the client benefits from witnessed washing by the caregiver.

The access stations, which are sometimes referred to nurse stations, may comprise an access station computer or hospital computer. The access station computer may be used by the user, sometimes referred to as a healthcare worker (HCW), to review the patients' files and input data and/or orders. The access station may comprise an identification reader such as a scanner, reader, or radio-frequency identification (RFID) reader. The server may provide the necessary information or data to the access station when the user logins or signs on using a RFID transmitter, which is also called a tag or badge.

The wash station may comprise a hand washing facility, an identification reader (e.g., scanner, reader, RFID reader), and a wash station computer. In one embodiment, the wash station computer may be a touch screen tablet computer with a camera. In that embodiment, the wash station computer may also comprise the scanner or reader such as RFID reader.

The room monitors or displays may be configured to receive a video or a still image transmission via the LAN (Wi-Fi/Ethernet/etc.) in order to show an individual or patient that the user or HCW is washing his or her hands before visiting the patient. The room monitor may also receive text messages to include scheduled visits, test schedules, test results, and can play educational or entertaining material between transmissions of the washing images of the user or HCW.

The server may have several administrative functions that allow data and images from the hand hygiene compliance system to be collected and/or used. These administrative functions may also allow the facility to update the videos used in the hand wash station, update users and RFID information, account information, user permissions, access authorizations, and maintain the scoreboard.

The scoreboard may preferably include a large screen video monitor located in a highly visible location or a gathering location in the hospital facility. The scoreboard information may be displayed with the metrics for washing compliance for each ward and HCW type. The most requested musical video may be announced and played. The information to be displayed may be authorized and maintained by the web administrator. The scoreboard monitor may access the link to the webpage containing this information via a wireless link or other LAN.

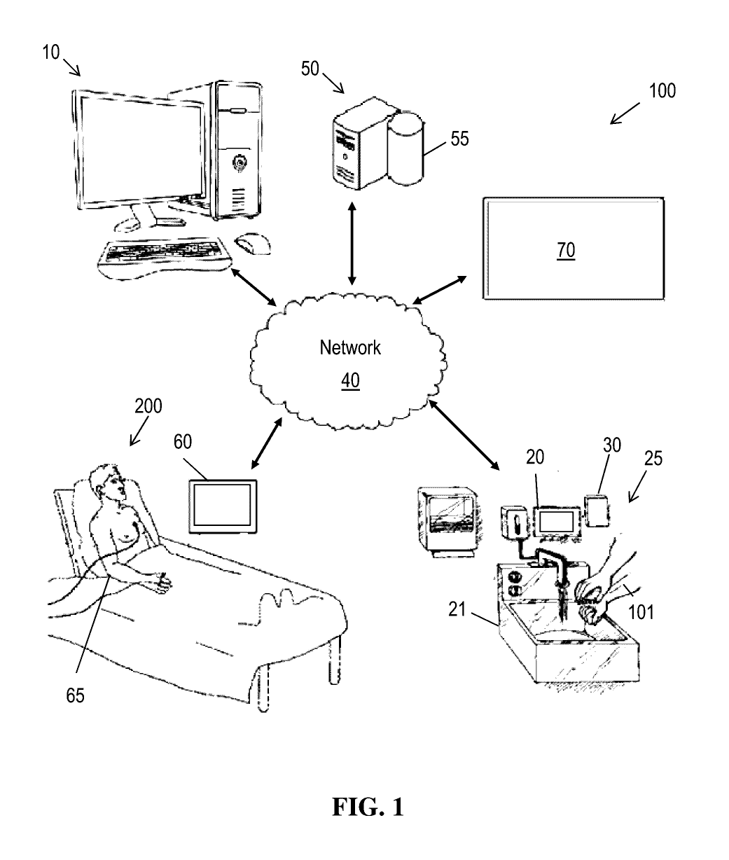

FIG. 1 is an illustration of one embodiment of a hand hygiene compliance system. As shown in FIG. 1, one embodiment of the hand hygiene compliance system 100 may comprise: an access station computer 10 (or hospital computer); a wash station computer 20; identification reader 30 (e.g., scanner, radio frequency identification reader); network 40; server 50; room monitor 60; and scoreboard 70. The access station computer 10 may be any computer system or device that accesses and/or stores patient data and records, including without limitation, information related to the patient history, physical exams, laboratory data, imaging results, physician notes, nurse's notes, vital sign data, medication information, intake/output data, documents, medication administration and procedure data, The access station computer 10 may also be configured to transmit a patient list and corresponding room numbers to the wash station computer 20 via the network 40.

Similarly, the wash station computer 20 may also be any computer system or device that communicates with the access station computer 10 or server 50. The wash station computer 20 is preferably located at or proximately near a wash station 21 and preferably retrieves and displays patient data and information (e.g., list of HCW's patients and corresponding room numbers) to the user 101. Importantly, the wash station computer 20 may display one or more videos (e.g., entertainment videos such as musical wash videos) to the user 101 in order to encourage the user 101 to wash his or her hands in order to increase hand-washing compliance. These videos may be retrieved from the server 50. In various embodiments, the wash station computer 20 may display various icons for video choices, which may include stored videos (e.g., entertainment videos) and video streaming from outside sources (e.g., content providers). When playing videos to the user 101, the videos preferably play for approximately 20 seconds and may show a time bar to provide an indication when the video may terminate or end.

The wash station computer 20 may also utilize various input mechanisms to allow the user 101 select certain patients and/or videos. For example, in one embodiment, the wash station computer 20 may utilize a touchscreen to allow the user 101 or HCW to select certain patient data or videos via physical touch. In other embodiments, the wash station computer 20 may also utilize voice recognition technology to accept patient and video selection choices by the user 101 without the user 101 using his or her hands. This may help promote proper hygiene, as the user 101 will not need to physically touch the wash station computer 20 with his or her hands.

When the user 101 signs in or logs in, the wash station computer 20 may also record all login or sign in times of the user 101 for recordkeeping. This login or sign in data may then be transmitted and stored in the server 50. This may also help promote and/or encourage proper hand hygiene.

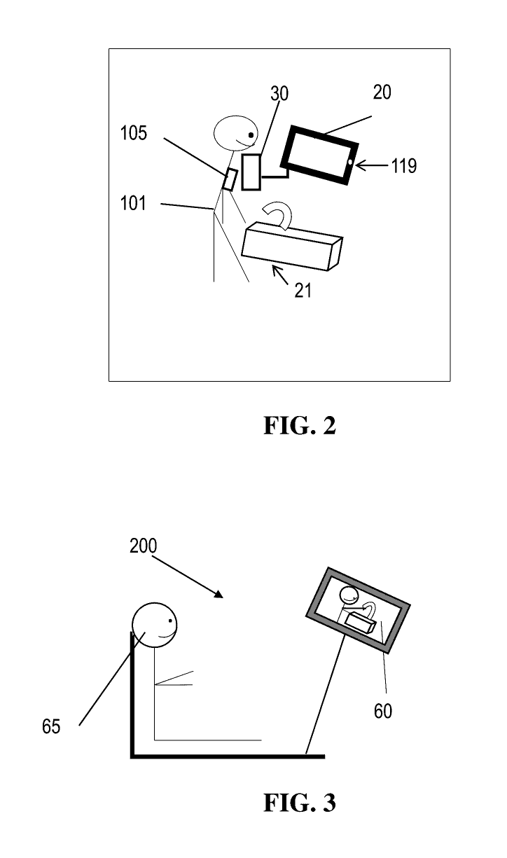

Importantly, the wash station computer 20 may also utilize a camera 119 (see FIG. 2) for sending one or more images of the user 101 washing his or her hands to the designated/target patient 65 (shown in FIG. 3). Specifically, these images may be transferred to room monitor 60 located within proximity of the target patient 65 via a network such as a local area network (Ethernet, Token ring, WiFi®, WiMax®). In other embodiments, the camera may instead capture or record a video of the washing of the user's hands, and this video may be transmitted to the room monitor 60 of the target patient 60.

FIG. 1 also shows that the hand hygiene compliance system 100 may also comprise an identification reader 30, which may be a scanner or reader such as a badge reader. The identification reader 30 is preferably in communication with the wash station computer 20 and may be physically coupled or integrated with the wash station computer 20. In some embodiments, when the user 101 logs in or signs in with his or her badge 105 (shown in FIG. 2), the wash station computer 20 may record all sign in and login events of that user 101. The badge 105 may also communicate with the identification reader 30 using various protocols and technologies such as WiFi®, BlueTooth®, WiMax®, iBeacon®, and near field communication (NFC). This may depend upon the distance between the badge 105 and identification reader 30. For example, in one embodiment, the identification reader 30 may read or scan the badge 105 via iBeacon® technology by placing the badge 105 within approximately one meter from the identification reader 30. In another embodiment, the badge 105 may connect wirelessly with the identification reader 30 via near field communication (NFC) protocol by placing the badge 105 within approximately 10 centimeters from the identification reader 30.

The badge 105 is generally worn by the user 101 who is usually employee or HCW, so that the badge 105 may be associated with that user 101. The badge 105 may also help document or record the user 101 when the user 101 logs into the wash station computer 20. In another embodiment, the badge 105 may comprise a transceiver as a single component for transmitting and receiving wireless signals. In an alternative embodiment, the badge 105 may comprise a transmitter and receiver as separate components. Preferably, the transceiver or transmitter is configured to emit various wireless signals in order to be discoverable and to exchange data with nearby identification readers 30. For example, in one embodiment, the badge 30 may emit one or more advertising packets in order to be discoverable by a nearby identification reader 30.

FIG. 1 also shows that the hand hygiene compliance system 100 may utilize a network 40. As discussed above, the network 40 may be any telecommunications network that allows devices within the hand hygiene compliance system 100 to exchange data. These networked devices may exchange data with each other using a data link. The connections between nodes of the network 40 may be established using either cable media or wireless media. Examples of such networks 40 may be a local area network or wide area network. The networked devices may include without limitation, an access station computer 10, wash station computer 20, server 50, room monitor 60, and scoreboard 70. These devices may be networked together when one device is able to exchange information with the other device, whether or not they have a direct connection to each other. The network 40 may utilize various transmission mediums to carry their signals and may utilize various communication protocols

The server 50 may be a computer system or computer program that manages access to a centralize resource or service in the network 40 and may function as a repository for information and data pertaining to patients and employees (e.g., HCWs) associated with a particular hospital or facility. The server 50 may comprise a database 55, which may be the repository for storing such information, and may be wirelessly connected to the access station computer 10 and wash station computer 20 via a local area network (LAN), wireless area network (WAN), Internet, or World Wide Web. The Internet may be a computer network comprising a worldwide network of computer networks that utilize the TCP/IP network protocols to facilitate data transmission and exchange. In the event that the access station computer 10 and wash station computer 20 have access to the Internet, users may transmit, upload, or send employee or patient data to a computer-readable storage device of a server 50.

In various embodiments, the server 50 may communicate with the access station computer 10 and send a patient list with names and room numbers to the wash station computer 20. The server 50 may also send videos to the wash station computer 20. The server 50 may record all sign ins and logins with the identification reader 30. In some embodiments, the server 50 may also receive and store images of the user 101 washing and may send those images to the room monitor 60, so that the patient 65 may view the images.

Additionally, the server 50 may function as a compliance log and scorecard. For instance, the server may calculate compliance as follows:

COMPLIANCE=ΣWASH ACTIONS/OPPORTUNITIES TO WASH

where, the wash actions are triggered recordings of the identification reader 30 of the user 101 washing and the opportunities are listed patients, which the user 101 has reviewed on the access station computer 10 or hospital computer.

Additionally, the server 50 may analyze which videos are frequently selected, so that awards may be given to those most viewed videos. These awards and compliance data may be displayed on a scoreboard 70 that is communicated within the network 40 of the hand hygiene compliance system 100. Such information may include, without limitation, best compliance award, user or HCW type (e.g., Intensive Care Unit, Emergency Room, etc . . . ), and the most watched video.

In various embodiments, an administrator, such as a web administrator, may maintain the server 50 and/or website. The administrator may also configure access and security to the hand hygiene compliance system 100 and may update video choices for the wash station computer 20. The administrator may also manage the transmission of these videos and may update the badges 105 and the identification reader 30.

The room monitor 60 may be any electronic display comprising a device that receives signals from a computer (e.g., wash station computer 20) via the network 40 and displays the signal on an electronic screen. The monitor 60 may include the physical surface on which image or video data is visually rendered so that it can be seen, and may comprise circuitry and other elements for rendering the image or video information graphically. The monitor 60 may further comprise audio components for producing acoustic signals in conjunction with the rendered image or video data. In one embodiment, the room monitor 60 may be located in patient's room and near the patient 65 for viewing. In this embodiment, the patient 65 may view one or more images captured by a camera 119 of a wash station computer 20 and the images may show the user 101 washing at that wash station. In other embodiments, the room monitor 60 may receive a video transmission from the camera 119 of a wash station computer 20 and may show a video transmission of the user 101 washing. The video transmission may be a sequence of frames or images that can be rendered to produce the time-dependent view of the visually perceptible content. In various embodiments, the room monitor 60 may display other material to the patient 65 for educational or entertainment purposes, and these materials may be interrupted when the user 101 is washing at the wash station. In other embodiments, the room monitor 60 may also receive text messages to include scheduled visits, test schedules, and test results.

Similarly, the scoreboard 70 may be an electronic display comprising a device that receives signals from a computer (e.g., server 50, access station computer 10) and displays the signal on an electronic screen. Unlike the room monitor 60, the scoreboard 70 is preferably not located within a patient's room and preferably does not receive any image or video feed from a wash station computer 20. Rather, the scoreboard 70 may be located at a highly visible location or a gathering location in the hospital or facility. The scoreboard 70 may display information regarding metrics for washing compliance for each ward and the user or HCW type. The most requested video from the wash station computers 20 may be announced and played. The information to be displayed on the scoreboard 70 may be authorized and maintained by the web administrator. The scoreboard 70 may also access a link to a webpage containing such information via the network 40.

FIG. 2 is an illustration of one embodiment of a wash station and shows the wash station in more detail. As shown in FIG. 2 shows that one embodiment of the wash station 25 may comprise a wash station computer 20, an identification reader 30 (e.g., RFID reader), and a wash station 21. FIG. 2 shows that the wash station computer 20 is preferably located at or proximately near a wash station 21. The wash station computer 20 may retrieve and displays patient data and information (e.g., list of user's or HCW's patients and corresponding room numbers) to the user 101. Importantly, the wash station computer 20 may display one or more videos (e.g., musical wash videos) to the user 101 in order to encourage the user 101 to wash his or her hands in order to increase hand-washing compliance. These videos may be retrieved from the server 50, and in various embodiments, the wash station computer 20 may display various video choices, which may include stored videos (e.g., musical wash videos) and video streaming from outside sources (e.g., content providers).

The user 101 may have a badge 105 (e.g., RFID badge). The wash station computer 20 may have a camera 119 and may be a touchscreen tablet computer. When the user 101 such as a HCW signs in or logs in, the wash station computer 20 may also record all login times of the employee or HCW for recordkeeping. This login or sign in data may then be transmitted and stored in the server 50. This may also help promote and/or encourage proper hand hygiene. The camera 119 may be used for sending one or more images of the user 101 washing his or hands to the target patient 65. Specifically, these images may be transferred to room monitor 60 located within proximity of the target patient 65 via a network 40 such as a local area network (Ethernet, Token ring, WiFi®, WiMax®). In other embodiments, the camera 119 may instead capture or record a video of the washing of the user's hands, and this video may be transmitted to the room monitor 60 of the target patient 65.

FIG. 3 is an illustration of one embodiment of a room monitor for a patient. FIG. 3 shows that the room monitor 60 (also referred to as a patient monitor) may be located in a patient room 200 within viewing distance of a patient 65. The patient 65 may view one or more images captured by a camera 119 of a wash station computer 20 and the images may show the user 101 or HCW washing at that wash station. In other embodiments, the room monitor 60 may receive a video transmission from the camera 119 of a wash station computer 20 and may show a video transmission of the user 101 washing.

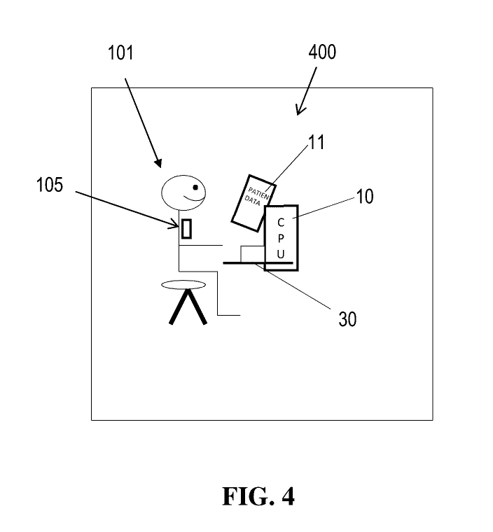

FIG. 4 is an illustration of one embodiment of access station with an access station computer. As shown in FIG. 4, one embodiment of the access station 400 may comprise an access station computer 10, monitor 11, and identification reader 30, which may be an RFID reader. The access station computer 10 may allow the user 101 to access patient data and records. The access station computer 10 may also be configured to transmit a patient list and corresponding room numbers to the server 50 or wash station computer 20 via the network 40.

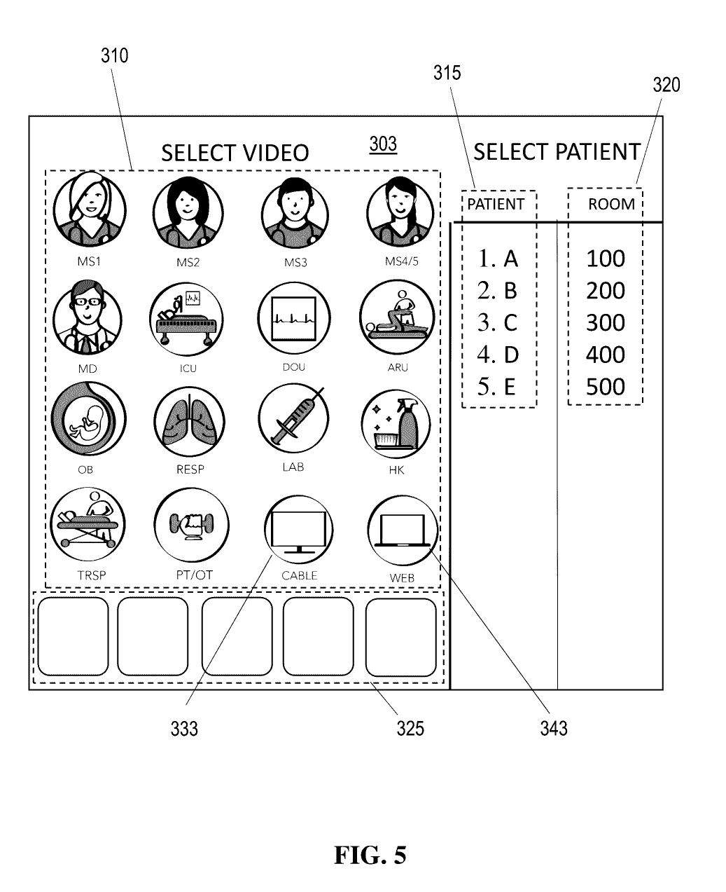

FIG. 5 shows one embodiment of a graphical user interface that is displayed to the user 101 when accessing the wash station computer 20. After the user 101 has his or her badge 105 read by the identification reader 30, the user 101 may be presented with screen 303 on the wash station computer 20. The screen 303 may be a touch screen that allows the user to directly select video options by touching or pressing various icons 310 (e.g., MS1, MS2, MS3, MS4/5, MD, ICU, DOU, ARU, OB, RESP, LAB, HK, TRSP, PT/OT, CABLE, WEB), and each icon 310 may correspond to a particular set of videos 325. Preferably, the screen 303 may display a selection of videos 325 to be played on the wash station computer 20 as the user 101 washes his or her hands. The videos 325 may include a default selected video sponsored by various departments such as medical surgery 1 (MS1) and intensive care unit (ICU). The user 101 may either let the default video play or may select one of the specific videos 325 for hand washing. FIG. 5 also shows that, in addition to videos 325 sponsored by various departments, the user may also be able to select other video options, such as content provider 333 or web provider 343. Content provider 333 may provide video streaming from a third party source such a cable company, and web provider 343 may provide access to data streaming from the Internet.

Importantly, the screen 303 of the wash station computer 20 may provide patient data, which may include a list the target patients 315 to be visited by the user 101. The patient data may include the room 320 to which each corresponding patient is located. The user 101 may then select the patient 315/room 320 and this action is recorded in the hand hygiene compliance system 100.

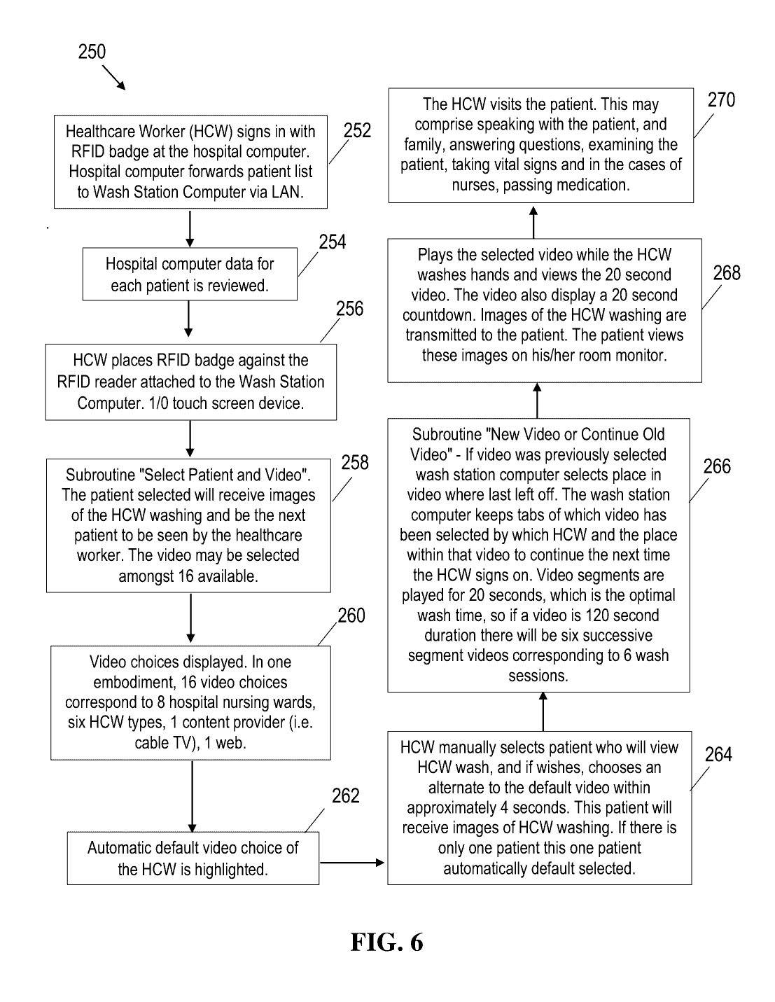

FIG. 6 is a flow block diagram of one embodiment of the method using the hand hygiene compliance system. As shown in FIG. 6, one embodiment of the method 250 may comprise steps 252, 254, 256, 258, 260, 262, 264, 266, 268, 270. At step 252, the user 101 such as a HCW may sign in with a badge 105 such as an RFID badge at the access station 400. The identification reader 30 may read the badge 105, and in response, the access station computer 10 may provide patient data. The user 101 may review the data and select a schedule of patients to be visited (i.e., target patients). The list of patient(s) may be entered/selected in an order that they will be visited. The access station computer 10 may then forward the patient list to applicable wash station computer 20 via the network 40. The patient data may also be reviewed at the access station computer 10 at step 254.

In step 256, the user 101 may then start his or her rounds by visiting the wash station 21, which is preferably within close proximity to the first target patient 65 to be visited. The user 101 also may place his or her badge 105 to the identification reader 30 that is coupled to or associated with wash station computer 20. This action may display screen 303, shown in FIG. 5. In step 258, the user may select a hand washing video and the next target patient 65 to be visited. The patient selected 65 will receive images (still or video) of the user 101 or HCW washing and will be the next target patient 65. The video may be selected amongst, for example, sixteen (16) videos that are available, as shown in FIG. 5.

In step 260, video choices are displayed on screen 303. In the embodiment, as shown in FIG. 5, the sixteen video choices may be shown and may correspond to eight hospital nursing wards, six worker types, a content provider (i.e., cable TV, satellite), and one other source outside hospital (WEB). Preferably, the automatic default video choice of user 101 is highlighted, as shown in step 262. The user 101 or HCW may manually select the specific patient 65 that will view the user 101 as the user 101 washes his or her hands at step 264. The user may also select an alternate video to the default video, which will automatically start to play after a short delay. The selected patient 65 will receive images (still or video) of the user 101 washing. If there is only a single patient 65 to be visited this patient 65 may be automatically selected by default.

In step 266, the user 101 may select a “New Video” or “Continue Old Video”. If a video was previously selected on a wash station computer 20, it may select the same time when the video was last played. The wash station computer 20 and/or server 50 may keep logs on which videos have been selected by which user 101 or HCW and the place within that video to continue the next time the user 101 signs on. Video segments may be played for approximately twenty (20) seconds, which is the optimal wash time. Thus, if a video is 120 seconds in length, for example, there will be six successive segment videos corresponding to six wash sessions.

The selected video preferably plays for 20 seconds and the user 101 washes his or her hands and views the video at step 268. Images of the user 101 washing are transmitted to the patient 65, and the patient 65 may view these images on his/her room monitor 60.

In step 270, the user 101 or HCW may visit the patient 65, and the visit may comprise speaking with the patient 65 and family, answering questions, examining the patient 65, taking vital signs, and, in the cases of nurses, distributing medication. After seeing the patient 65, the wash sequence may be repeated before visiting the next patient 65. After all patients 65 are visited, the user or HCW may visit the access station computer 10 and update information on the patients 65. Alternatively, the user 101 or HCW may update the patient record after each patient 65 rather than waiting until all patients 65 have been visited.

For privacy purposes, the patient monitor 60 preferably lacks a camera 119 and/or does not transmit images of the patient 65 to wash station computer 20, which may be in a public location.

Additional features of the hand hygiene compliance system may include additional identification readers 30 in the patient room 200, so that the hand hygiene compliance system 100 may be notified that the user 101 visited the patient 65. In some embodiments, the hand hygiene compliance system 100 may determine whether the user 101 completed the hand washing protocol before visiting that patient 65. This may allow for a more accurate compliance determination. It might also allow the hand hygiene compliance system 100 to warn a user 101 that he or she is not in compliance.

In other embodiments, the system administration and control may comprise a web administration, which controls access, security, generating reports, database management, and notifications. The database of the hand hygiene compliance system 100 preferably stores the videos and/or still images (collectively referred to as “images”) that are sent to the patients 65 as proof of compliance. The hand hygiene compliance system 100 may also store the RFID swipes and which videos are most popular. The storage of this data allows the generation of compliance reports and other metrics related to the hand hygiene compliance system 100. In one embodiment the compliance summaries and metrics may be displayed on a scoreboard 70. This may further improve compliance by making it known who is not compliant and by spurring competition to be the most compliant workers and/or most compliant group.

Although the FIG. 6 shows that RFID is used, any type of wireless signal or communication system may be used, including Bluetooth®, Wi-Fi, and/or cellular signals. In other embodiments, a hardwired system or entry of a personal identification number (PIN) may be used to identify when a user is at a patient 65, a wash station, or at an access station.

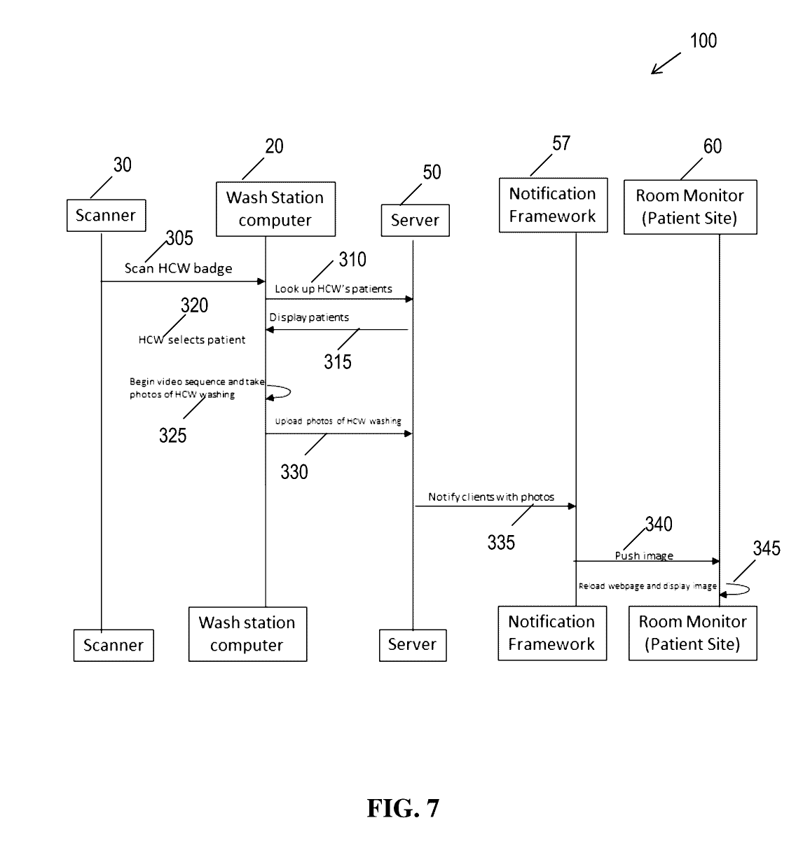

FIG. 7 is another flow diagram of one embodiment for the hand hygiene compliance system and shows how a user utilizes the hand hygiene compliance system. As shown in FIG. 7, one embodiment of the hand hygiene compliance system 100 may comprise an identification reader 30, wash station computer 20, server 50, notification network 57, and room monitor 60. FIG. 7 preferably shows the steps after the user 101 has logged in the access station computer 10 or hospital computer and retrieves the patient data. The user 101 may first sign in with a badge 105 (e.g., RF identification badge) at the access station computer 10, and in response, the access station computer 10 may then forward a patient list to the wash station computer 20 or server 50 via the network 40. Upon receiving the patient list, the user 101 may review the patient data and then travel to the first target patient 65 to be visited.

Now, at step 305, the user 101 may then login or sign in with his or her badge 105 at the identification reader 30 coupled to or within proximity of the wash station computer 20. As discussed above, the identification reader 30 may be a device that scans or reads a badge to identify and login the user 101. Upon scanning the badge, the wash station computer 20 looks up the target patients and displays a patient list to the user 101, as shown in steps 310 and 315. The user 101 may then be prompted to select a patient 65 and video at step 320. The selected patient or target patient will preferably be able to receive images or videos of the user 101 washing and will preferably be the next patient 65 to be seen by the user 101.

When displaying patient names and video choices to the user 101, the wash station computer 20 may offer several videos. For instance, in one embodiment, the wash station computer 20 may offer sixteen videos, which may correspond to eight hospital nursing wards, six types of HCWs, one third party streaming option (e.g., cable/television), and web. In this embodiment, the automatic video choice may be highlighted. At this point, the user 101 may also manually select the patient 65 (i.e., target patient) who will view washing of the user 101, and optionally, an alternate to the default video within a short time period (e.g., approximately 4 seconds). If a different video is selected, the wash station computer 20 may play that new video where the last video was left off. The wash station computer 20 and server 50 may record these video selections, the identity of the user 101 selecting the video and the time, in which that video will continuing playing when that user 101 signs on again. In one embodiment, video segments may be played for 20 seconds, which is the optimal wash time. Thus, if a video has a 120 second duration, there may be six successive segment videos corresponding to six wash sessions.

After selecting the patient 65 and video, a video sequence preferably takes place at step 325. During this time, the wash station computer 20 may play the selected video while the user 101 washes and views the video. In an embodiment, the video may display a twenty second time lapse or countdown, which may show the progression of the video. During this time, photos (or videos) of the user 101 washing are preferably captured by the camera 119 of the wash station computer 20. The captured photos may then be uploaded to the server 50 at step 330.

At step 335, the server 50 may notify the patient 65 that there are photos of the user 101 available, and the photos of the user 101 washing are then transmitted to the patient at step 340 via the room monitor 60 located within the patient room 200. The patient 65 may view these images on his/her room monitor. Here, the selected patient 65 or target patient may then review the images of the user 101 washing. The user 101 may then visit the patient 65 and may interact with the patient 65 (e.g., speaking with the patient and family, answering questions, examining the patient, taking vital signs, passing medication).

After visiting the patient 65, the wash sequence may repeat, depending whether the user 101 will see a different patient 65. If the user 101 does not visit another patient 65, the hand hygiene compliance system 100 may simply log the visitation of that patient 65. On the other hand, if the user 101 intends to immediately see new patient 65, the user 101 may scan his or her badge 105 at step 105 and select a new patient 65 at the wash station computer 20 at step 320. The process may then repeat.

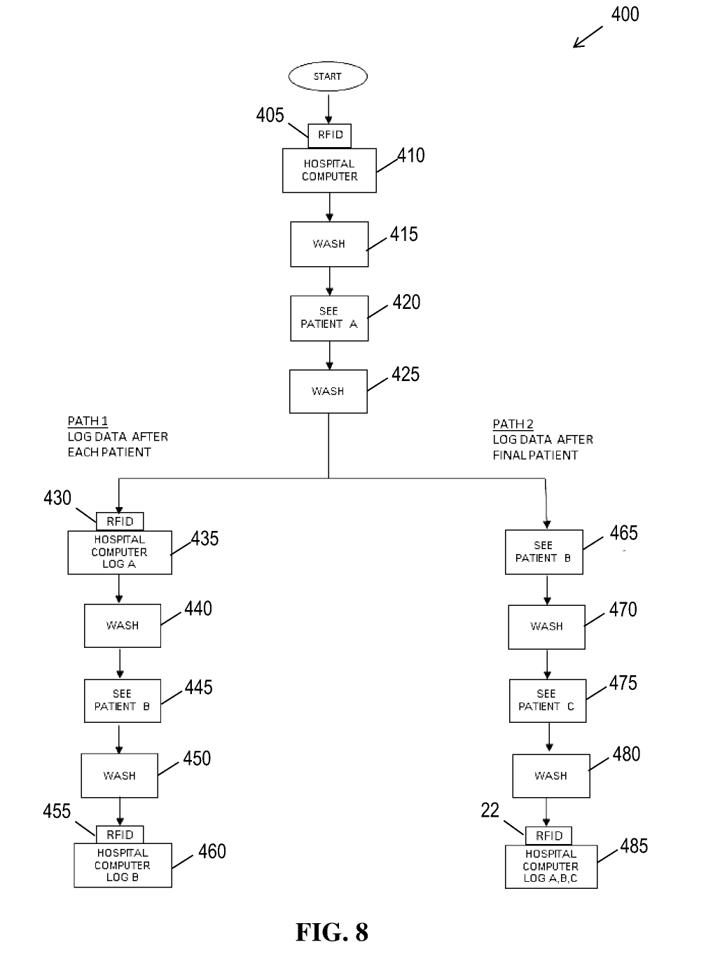

FIG. 8 is a flow chart of another embodiment of a method of using the hand hygiene compliance system. As shown in FIG. 8, another embodiment of the method 400 may comprise steps 405, 410, 415, 420. At steps 405 and 410, the user 101 or HCW may sign on to the access station computer 10 or hospital computer to review patient data. The patient list may then be transmitted from the access station computer 10 to the wash station computer 20 via the network 40 (e.g., LAN, WiFi®).

At step 415, the user 101 may proceed to the wash station and may sign onto the wash station computer 20 to select the target patient to see or visit (PATIENT A). The user 101 may also select the video to watch, wherein the duration of the video is usually approximately 20 seconds. As the wash station computer 20 plays the video, the user 101 preferably watches the video and washes his or her hands. Here, images of the user 101 or HCW are captured by the camera 119 of the wash station computer 20, and the images are then transferred to the room monitor 60 of the patient.

At step 420, the user 101 or HCW visits the target patient (PATIENT A). For example, the user 101 may speak with the patient and family, answer questions, examine the patient, take vital signs, and, in the cases of nurses, distribute medication.

At step 425, the user 101 signs back onto the wash station computer 20 to wash his or her hands. In the event that the user 101 does not select another target patient to see or visit, the hand hygiene compliance system 100 logs the data (e.g., records images or videos from washing at step 425, records badge sign in) and terminates the session. Thus, when the user 101 is ready to proceed to the next target patient, the user 101 may then perform steps 430, 435, 440, 445, 450, 455, 560.

Specifically, at steps 430 and 435, the user 101 or HCW may again sign on to the access station computer 10 or hospital computer to review patient data. The patient list may then be transmitted from the access station computer 10 to the wash station computer 20.

At step 440, the user 101 or HCW proceeds to the wash station 21 and signs onto the wash station computer 20. The user 101 then may select the next target patient to see or visit (i.e., PATIENT B). The user 101 also selects the video to watch, wherein the duration of the video is usually approximately 20 seconds. As the wash station computer 20 plays the video, the user 101 preferably washes his or her hands while watching the video. Here, images of the user 101 are captured by the camera 119 of the wash station computer 20, and the images are then transferred to the room monitor 60 of the patient.

At step 445, the user 101 visits the next patient, which is PATIENT B. For example, the user 101 may speak with the patient and family, answer questions, examine the patient, take vital signs, and, in the cases of nurses, distribute medication.

At step 450, the user 101 proceeds back to the wash station and signs back onto the wash station computer 20 to wash his or her hands. Like step 425, in the event that the user 101 does not select another target patient to see or visit, the hand hygiene compliance system 100 logs the data. Thus, the user 101 may proceed back to the access station computer 10 and update information on PATIENT B. Alternatively, the user 101 may update the patient record after each patient rather than waiting until all patients have been visited.

On the other hand, in the event that the user 101 chooses to see two additional patients (e.g., PATIENT B and PATIENT C) after visiting PATIENT A, the user 101 may perform steps 465, 470, 475, 480, 485 after step 425. Preferably, the user 101 has not yet log data of the first target patient (i.e., PATIENT A). Specifically, at step 425, the user 101 proceeds to the wash station 21 and signs onto the wash station computer 20 to select the next target patients (i.e., PATIENT B and PATIENT C). The user 101 may also select the next 20 second video to watch. As the wash station computer 20 plays the video, the user 101 preferably watches the video and washes his or her hands. Here, images of the user 101 are preferably captured by the camera 119 and then transmitted to the room monitor 60 of PATIENT B.

At step 465, the user 101 visits and interacts with the next patient, which is PATIENT B. After visiting PATIENT B, the user proceeds back to the wash station computer 20 at step 470 to wash his or her hands. Also, images of the user 101 are captured by the camera 119 of the wash station computer 20, wherein the images are then transferred to the room monitor 60 of PATIENT C.

At step 475, the user 101 visits and interacts with PATIENT C. After visiting PATIENT C, the user 101 then proceeds back onto the wash station computer 20 to wash his or her hands. Like step 425, in the event that the user 101 does not select another target patient to see or visit, the hand hygiene compliance system 100 logs the data. Thus, the user 101 may proceed back to the access station computer 10 and update information on PATIENTS A, B, and C.

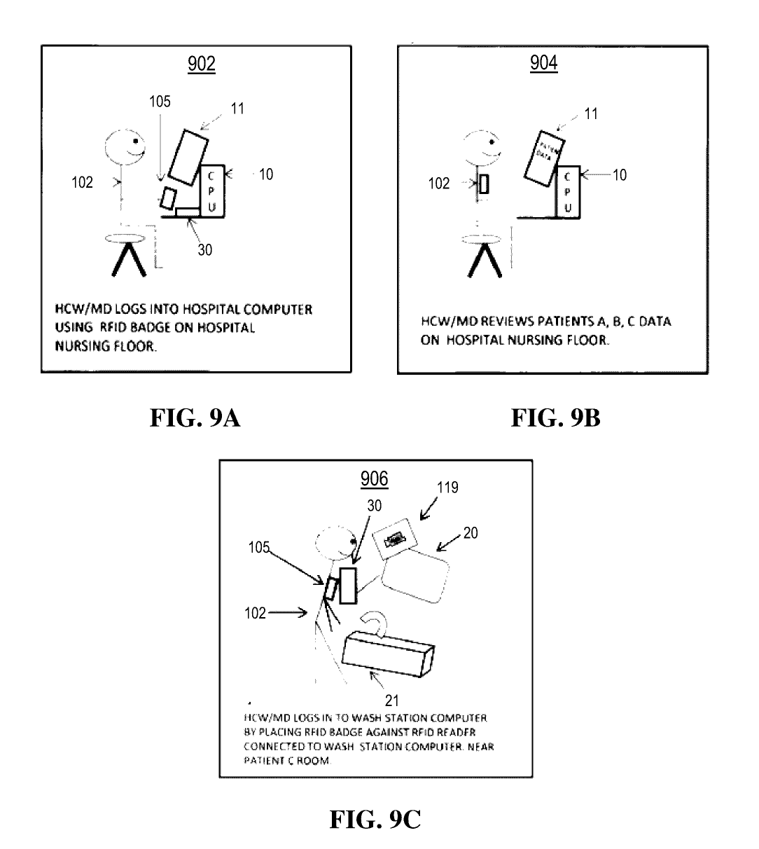

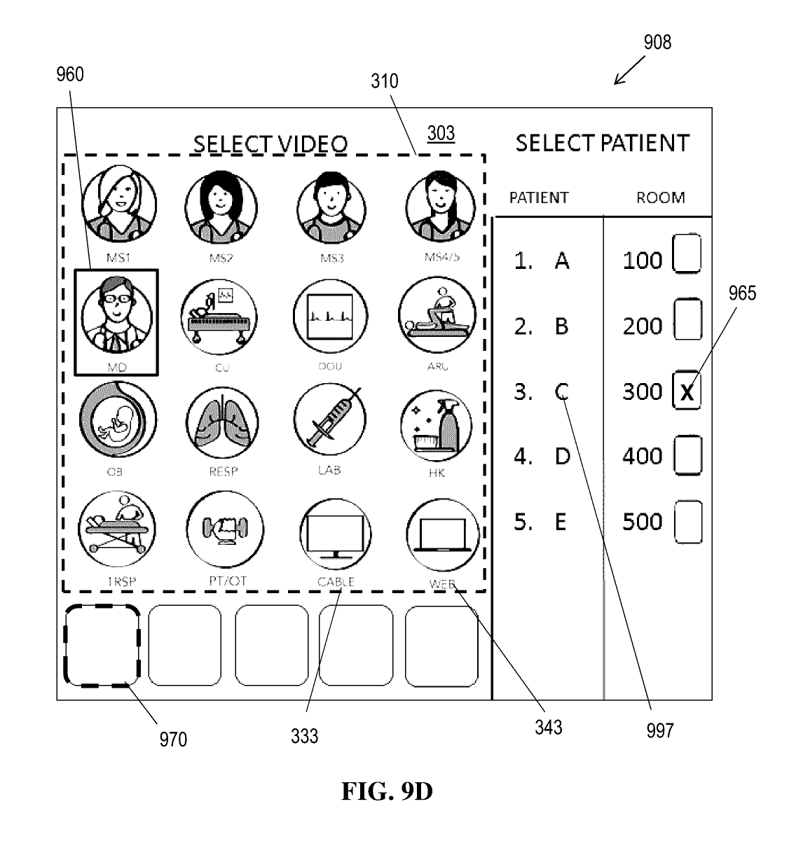

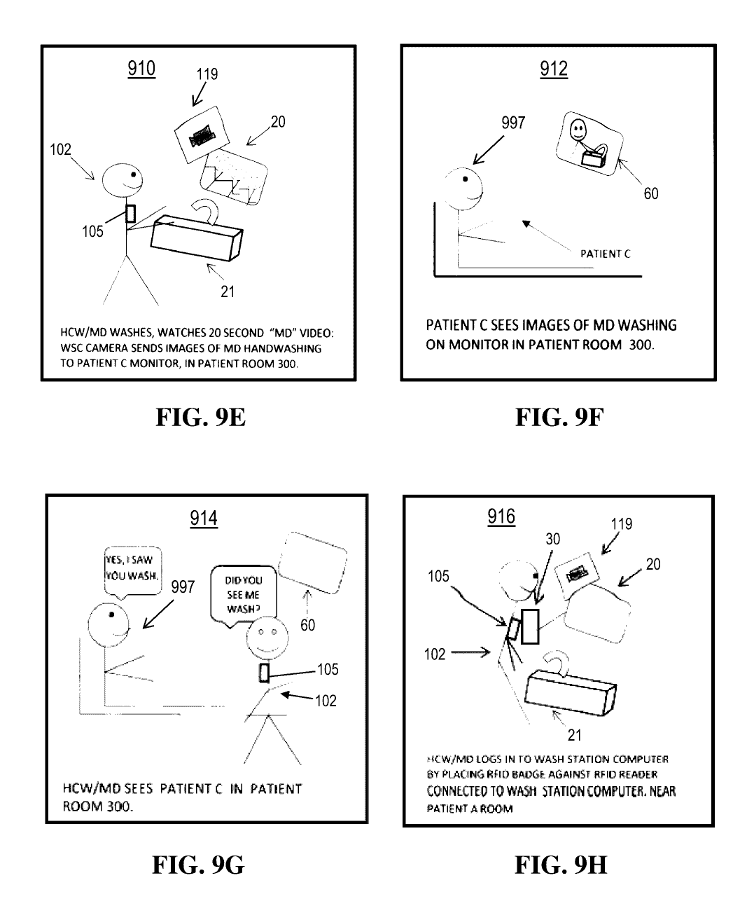

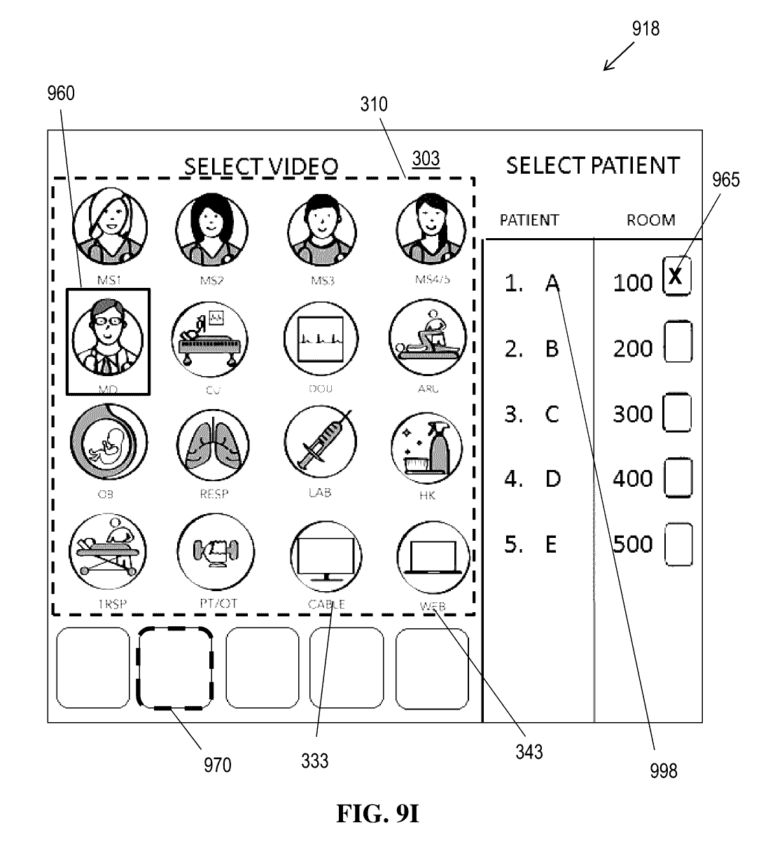

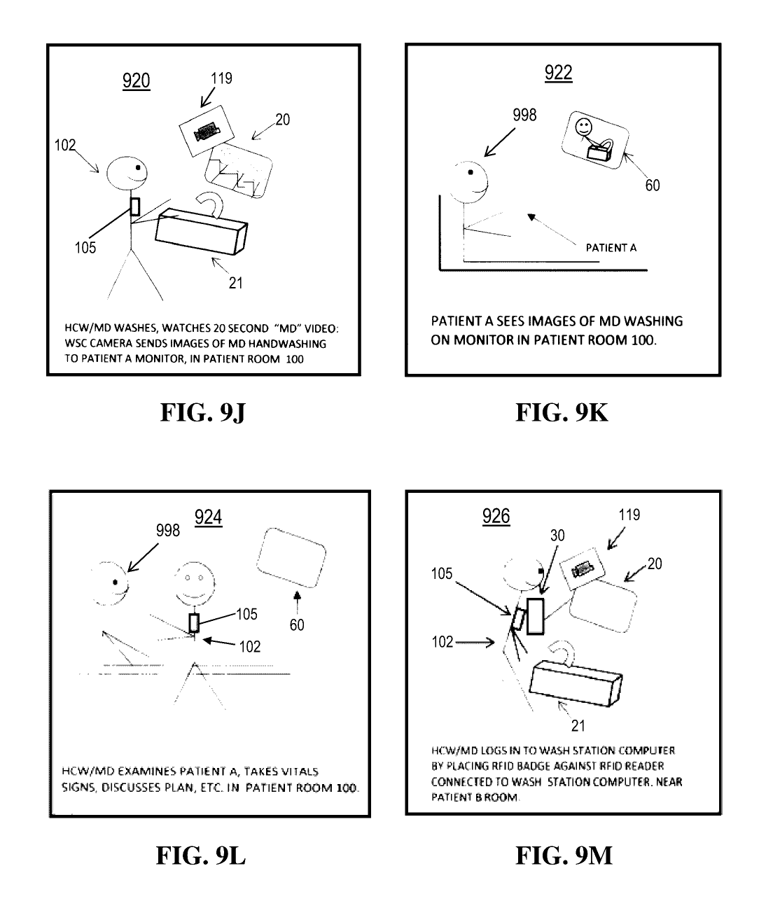

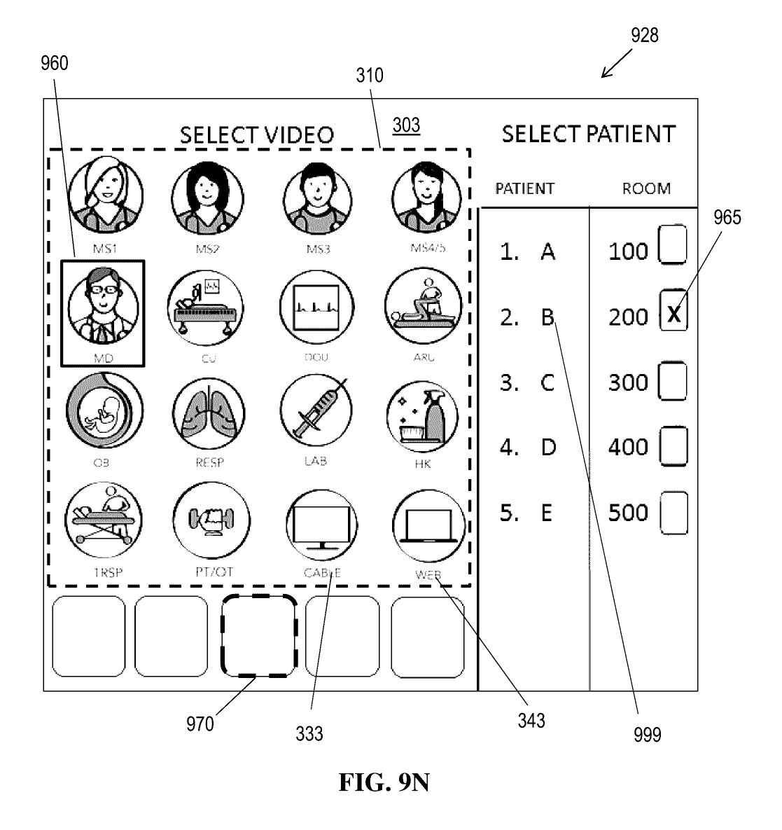

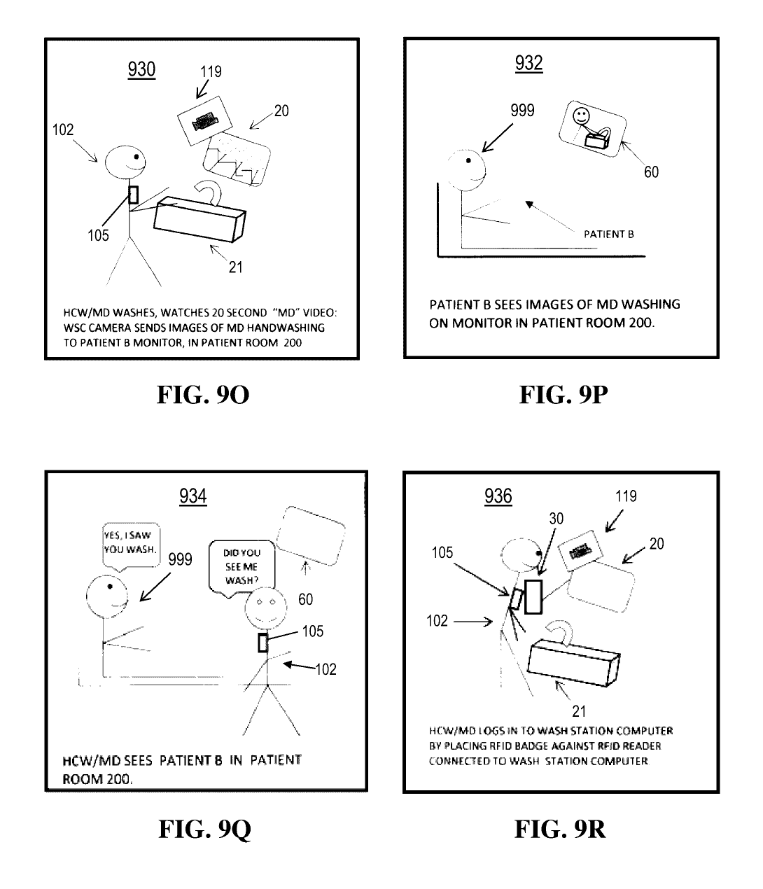

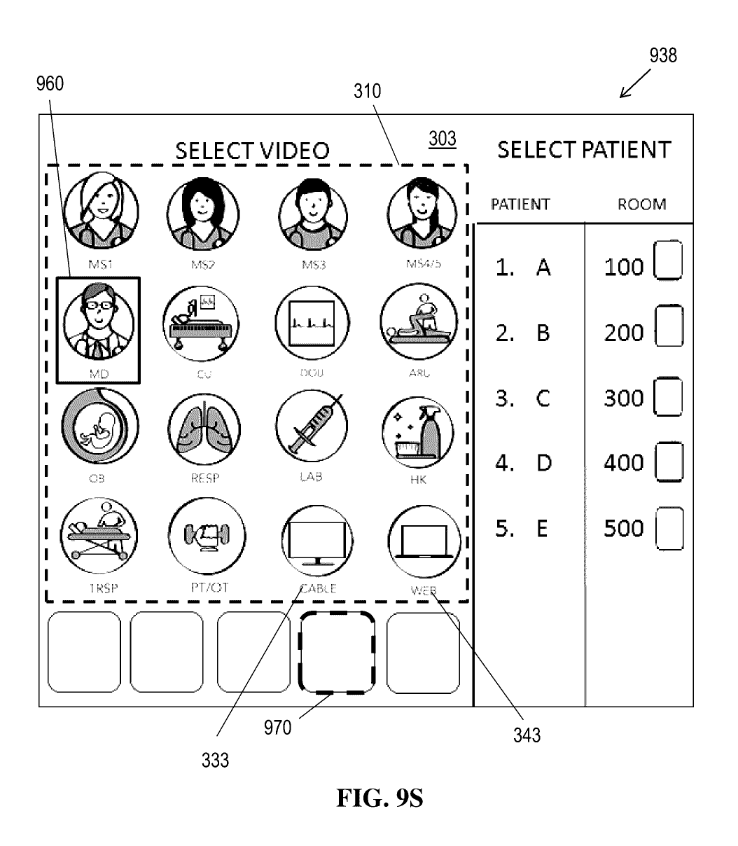

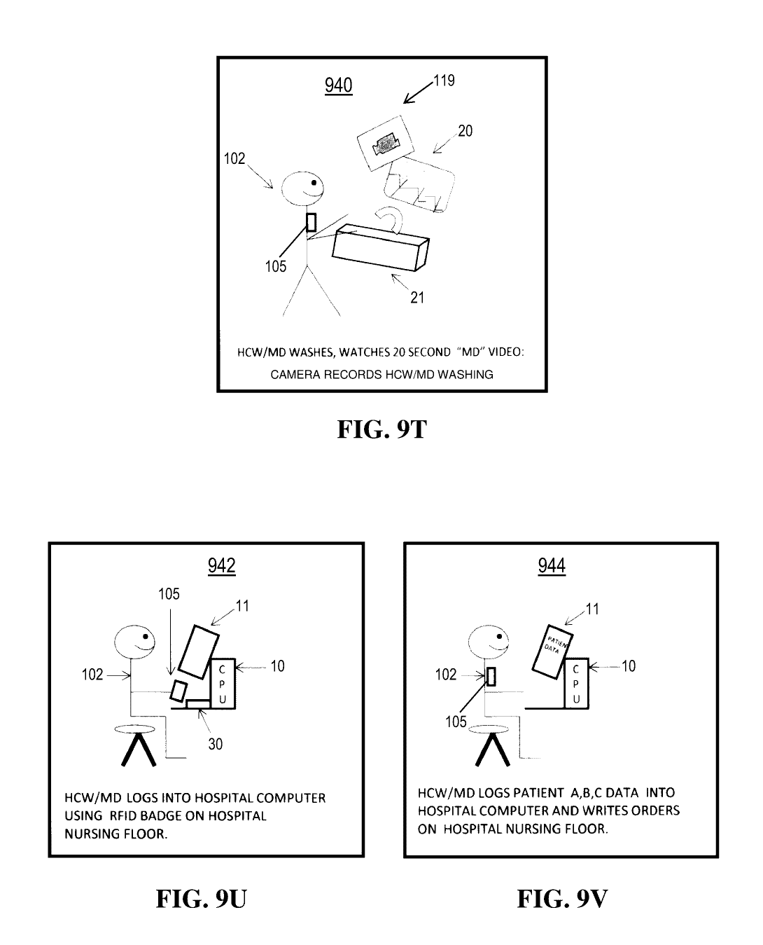

FIGS. 9A to 9V are illustrations of another embodiment of a method of using the hand hygiene compliance system and shows a HCW using the hand hygiene compliance system when visiting three patients consecutively. As shown in FIGS. 9A to 9V, another embodiment of the method may comprise steps: 902, 904, 906, 908, 910, 912, 914, 916, 918, 920, 922, 924, 926, 928, 930, 932, 934, 936, 938, 940, 942, 944. First, FIG. 9A shows that, at step 902, the user 101 or HCW 102 may sign in with his or her badge 105 at the access station computer 10 or hospital computer by placing the badge 105 near the identification reader 30. In response, the access station computer 10 may then forward the patient list to the wash station computer 20 via the network 40. Then, in step 902 shown in FIG. 9B, the HCW 102 may then view the monitor 11 of the access station computer 10 to review the patient data for the target patients that may be reviewed by the HCW 102. After reviewing the patient data, the HCW 102 may then proceed to the wash station 21.

FIG. 9C shows the HCW at the wash station 21. Here, in step 906, the HCW 102 may place the badge 105 against the identification reader 30 that is coupled to or in communication with the wash station computer 20. In one embodiment, the wash station computer 20 may be a tablet computer with a touchscreen display.

The HCW 102 may then view the screen 303 of the wash station computer 20, as shown in FIG. 9D. Here, the wash station computer 20 may then prompt the HCW 102 to select the “Patient” for the next target patient to be selected. The target patient may receive images of the HCW 102 washing, and this patient may be the next patient to be visited by the HCW 102. If there is only a single patient, this patient may be automatically selected by default.

After selecting the target patient 997 (e.g., PATIENT C), the wash station computer 20 may prompt the HCW 102 to select a “new video” or “continue the old video”. Here, FIG. 9D may show various icons 310 corresponding to different departments of the facility, wherein each department may provide various videos. In one embodiment, as shown in FIG. 9D, sixteen videos may be available to the HCW 102. In this embodiment, the icons 310 for the video choices, for example, may display videos corresponding to eight hospital nursing wards, six types of HCWs, one content provider 333, and one web provider 343. FIG. 9D also shows that the default video choice 970 may be highlighted. Here, the HCW 102 may manually select a target patient to be visited with his or her room number 965 and may choose an alternate to the default video within a short period of time. For instance, in one embodiment, the wash station computer 102 may provide the HCW 102 up to approximately four seconds to select an alternate video. Although FIGS. 9D, 9I, 9N, and 9S show sixteen icons, the hand hygiene compliance system 100 may provide any number of icons.

If the HCW 102 decided to allow the previously selected video 970 to run, the wash station computer 20 may continue to play the selected video 970 where the selected video 970 was last left off. The wash station computer 20 may record or log which video was selected by the HCW 102 and the last place within that selected video 970 to continue the next time the HCW 102 signs on. In a preferred embodiment, video segments may be played for approximately 20 seconds.

FIG. 9E shows step 910. Here, the wash station computer 20 may play the selected video 970 while the HCW 102 washes his or her hands. During this time, the HCW 102 is preferably entertained by the video 970. In various embodiments, the video 970 may display a time lapse bar, so that it may depict a twenty second countdown. Image of the HCW 102 washing are also preferably transmitted to the target patient at this time, as shown in FIG. 9F and in step 912. The patient may view these images on his or her room monitor 60.

Next, FIG. 9G shows step 914. Here, the HCW 102 preferably visits the target patient 997, which may be PATIENT C, and may interact with the target patient 997. The HCW 102 may also answer questions, examine the patient, take vital signs, provide medication, and the like.

After visiting the target patient 997, the HCW 102 may proceed to the wash station computer 20, shown in FIG. 9H in step 916. Here, the HCW 102 preferably places his or her badge 105 towards the identification reader 30 that is in communication with the wash station computer 20. The wash station computer 20 may show a screen 303, as in step 918, and then prompt the HCW 102 to select the next target patient 998 to be visited (e.g., PATIENT A) and video to watch. Again, the icons 310 for the video choices may be displayed, and the selected or default video 970 choice may be highlighted. At this point, the HCW 102 may manually select the target patient 998 who will view the washing of the HCW 102, and this target patient may receive images of the HCW 102 washing.

Again, after selecting the target patient 998 (PATIENT A), the wash station computer 20 may prompt the HCW 102 to select a “new video” or “continue the old video”. If the HCW 102 decided to allow the previously selected video 970 to run, the wash station computer 20 may continue to play the selected video 970 where the selected video 970 was last left off. The wash station computer 20 may record or log which video was selected by the HCW 102 and the last place within that selected video to continue the next time the HCW 102 signs on.

FIG. 9J shows step 920. Here, the wash station computer 20 may play the selected video 970 while the HCW 102 washes his or her hands. During this time, the HCW 102 is preferably entertained by the video 970. In various embodiments, the video may display a time lapse bar, so that it may depict a twenty second countdown. Images of the HCW 102 washing may also be transmitted to the target patient 998 at this time, as shown in FIG. 9K in step 922. The patient may view these images on his or her room monitor 60.

FIG. 9L shows step 924. Here, the HCW 102 then preferably visits the second target patient 998, and may speak with the patient 998 and/or the patient's family. After visiting and interacting the second target patient 998, the HCW 102 may proceed to the wash station computer 20 and preferably places his or her badge 105 towards the identification reader 30, as shown in FIG. 9M, step 926. The wash station computer 20 may then show the screen 303 shown in FIG. 9N and then prompt the HCW 102 to select the third target patient 999 (e.g., PATIENT B) to be visited. The wash station computer 20 may also prompt the HCW 20 to select a video to watch. Again, the icons 310 for the video choices may be displayed, and the selected or default video choice may be highlighted. At this point, the HCW 102 may manually select the patient who will view the washing of the HCW 102, and this target patient may receive images of the HCW 102 washing.

Again, after selecting the third target patient 999, the wash station computer 20 may prompt the HCW 102 to select a “new video” or “continue the old video”. If the HCW 102 decided to allow the previously selected video 970 to run, the wash station computer 20 may continue to play the selected video 970 where the selected video 970 was last left off. The wash station computer 20 may record or log which video was selected by the HCW 102 and the last place within that selected video to continue the next time the HCW 102 signs on.

FIG. 9O shows step 930. Here, the wash station computer 20 may play the selected video 970 while the HCW 102 washes his or her hands. During this time, the HCW 102 is preferably entertained by the video 970. In various embodiments, the video may display a time lapse bar, so that it may depict a twenty second countdown. Images of the HCW 102 washing are also preferably transmitted to the third target patient 999 at this time, as shown in FIG. 9P in step 932. The patient may view these images on his or her room monitor 60.

In step 934, as shown in FIG. 9Q, the HCW 102 then preferably visits the third target patient 999 (PATIENT B), and may interact with the patient 999 (e.g., answering questions, examining the patient, taking vital signs, and in the case of nurses, providing medication).

After visiting and interacting the third target patient 999, the HCW 102 may proceed to the wash station computer 20 and preferably places his or her badge 105 towards the identification reader 30 that is in communication with the wash station computer 20, as shown in FIG. 9R in step 936. Here, the wash station computer 20 may display screen 303, as shown in FIG. 9S and step 938, and then prompt the HCW 102 to select another target patient to be visited and video to watch. However, alternatively, the HCW 102 may choose not to select another patient. As a result, the wash station computer 20 may then prompt the HCW 102 to select a “new video” or “continue the old video”. If the video was previously selected, the wash station computer 20 may continue to play the selected where the selected video was last left off. The wash station computer 20 may record or log which video was selected by the HCW 102 and the last place within that selected video to continue the next time the HCW 102 signs on. During this time the HCW 102 preferably washes his or her hands, as shown in FIG. 9T and step 940.

After visiting the three target patients 997, 998, 999, logging into the wash station computer 20, and washing his or her hands, the HCW 102 may then visit the access station computer 10 and login into the access station computer 10 by placing his or her badge 105 near the identification reader 30, as shown in FIG. 9U and step 942. During this time, HCW 20 may update the patient data for the three target patients and may also issue new orders. This step 944 is shown in FIG. 9V.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A hand hygiene compliance system, comprising:
at least one wash station computer; and
at least one room monitor;
wherein said at least one wash station computer is located at a wash station and is configured to access a patient data from a server through a network;
wherein said at least one wash station computer displays to a user said patient data to allow said user to select at least one target patient to be visited;
wherein said at least one target patient is associated with said at least one room monitor; and
wherein said wash station computer comprises a camera configured to capture one or more images of said user washing, said one or more images being transmitted to said at least one room monitor associated with said at least one target patient, such that said at least one room monitor displays said one or more images of said user washing to said at least one target patient.

2. The system of claim 1, wherein said at least one wash station computer displays to said user a plurality of videos; and
wherein said at least one wash station computer is configured to allow said user to select at least one of said plurality of videos to be played during washing.

3. The system of claim 2, further comprising at least one access station computer located at an access station and in communication with said server, said at least one access station computer being configured to transmit said patient data to said at least one wash station;
wherein said access station is configured to recognize said user; and
wherein said at least one wash station is configured to recognize said user.

4. The system of claim 3, wherein said one or more wash stations comprise a first identification reader in communication with said at least one wash station computer and is configured to recognize a badge associated with said user; and
wherein said at least one access station comprises a second identification reader that is configured to recognize said badge associated with said user.

5. The system of claim 2, wherein said wash station computer comprises a touch screen display.

6. The system of claim 2, wherein said patient data displayed to said user is based on an identity of said user.

7. The system of claim 6, wherein said patient data comprises a plurality of patient names and a plurality of patient room numbers; and
wherein said plurality of patient names and said plurality of patient room numbers correspond to each other.

8. The system of claim 7, further comprising a server having a database; and
wherein said database is configured to store said patient data, said one or more images of said user washing, and said identity of said user.

9. The system of claim 8, wherein said at least one access station computer is configured to accept a plurality of visitation data related to said at least one target patient after visiting.

10. The system of claim 9, wherein said server, said at least one access station computer, said at least one wash station computer, and said at least one room monitor are in communication via a network.

11. The system of claim 10, wherein said server is configured to generate a plurality of usage reports and a plurality of compliance reports.

12. The system of claim 11, wherein at least a summary of said plurality of usage reports and said plurality of compliance reports are accessible to said user.

13. The system of claim 2, wherein said at least one selected video is displayed to said user for approximately 20 seconds to serve as a timer for washing.

14. The system of claim 13, wherein said at least one selected video is longer than 20 seconds, and said at least one wash station computer displays a different approximately 20 second portion of said at least one selected video when said user selects said at least one selected video a second time at a second washing.

15. A hand hygiene compliance system, comprising:
one or more access station computers;
one or more wash station computers; and
one or more room monitors;
wherein said one or more access station computers are located at one or more access stations and are configured to allow a user to access a patient data from a server through a network and transmit said patient data to said one or more wash station computers;
wherein said one or more wash station computers are located at one or more wash stations and are also configured to display to a user said patient data to allow said user to select one or more target patients to be visited after washing;
wherein said one or more wash station computers are also configured to allow said user to select one or more videos to be played during said washing;
wherein said one or more target patients are associated with said one or more room monitors;
wherein said one or more wash station computers comprise one or more cameras configured to capture one or more images of said user washing, said one or more images being transmitted to said one or more room monitors associated with said one or more target patients, such that said one or more room monitors display said one or more images of said user washing to said one or more target patients after washing;
wherein said one or more wash stations comprise a first radio frequency identification reader that is configured to recognize a radio frequency identification badge associated with said user; and
wherein said one or more access stations comprise a second radio frequency identification reader that is configured to recognize said radio frequency identification badge associated with said user.

16. The system of claim 15, wherein said one or more wash station computers comprise a touch screen display;
wherein said patient data displayed to said user is based on an identity of said user and comprises a plurality of patient names and a plurality of patient room numbers; and
wherein said plurality of patient names and said plurality of patient room numbers correspond to each other.

17. The system of claim 16, further comprising a server, having a database; and
wherein said database is configured to store said patient data, said one or more images of said user washing, and said identity of said user;
wherein said one or more access station computers are configured to accept a plurality of visitation data related to said one or more target patients after visiting.
wherein said server, said one or more access station computers, said one or more wash station computers, and said one or more room monitors are in communication via a local area network.

18. The system of claim 17, wherein said server is configured to generate a plurality of usage reports and a plurality of compliance reports; and
wherein at least a summary of said plurality of usage reports and said plurality of compliance reports are accessible to said user.

19. The system of claim 18, wherein said plurality of videos are displayed to said user for approximately 20 seconds and serve as a timer for washing.

20. The system of claim 19, wherein at least one of said one or more selected videos are longer than 20 seconds, and said one or more wash station computers display a different approximately 20 second portion of said one or more videos when said user selects a second video during a second washing.
